(19) United States
(12) Patent Application Publication
(10) Pub. No.: US 2015/0116809 A1
(43) Pub. Date: Apr. 30, 2015

(54) OPTICAL MODULE

(71) Applicant: Mitsubishi Electric Corporation, Chiyoda-ku (JP)

(72) Inventors: Kenichi UTO, Tokyo (JP); Mizuki SHIRAO, Tokyo (JP)

(73) Assignee: Mitsubishi Electric Corporation, Chiyoda-ku (JP)

(21) Appl. No.: 14/459,458

(22) Filed: Aug. 14, 2014

(30) Foreign Application Priority Data
Oct. 31, 2013 (JP) 2013-226508

(51) Int. Cl. G02F 1/015; G02F 1/017; G02F 1/21; G02F 1/01

(52) U.S. Cl. CPC G02F 1/015; G02F 1/0102; G02F 1/017; G02F 1/218; G02F 2001/212
USPC 359/245

(57) ABSTRACT

A metal stem is provided with a through-hole, a temperature control module is mounted thereon, and a metal protrusion is formed integrally therewith. A lead pin includes a through section inserted in the through-hole of the metal stem, and an inner lead section continued from one end of the through section and extending up to the tip. The temperature control module is thermally connected to a semiconductor optical modulation element that is electrically connected to the inner lead section. The protrusion faces the inner lead section.

### CROSS-REFERENCE TO RELATED APPLICATION

This application claims the benefit of Japanese Patent Application No. 2013-226508, filed on Oct. 31, 2013, the entire disclosure of which is incorporated by reference herein.

### FIELD

This application relates to an optical module in which the temperature of a semiconductor optical modulation element is controlled by a temperature control module.

### BACKGROUND

As optical modules capable of transferring 10-Gbps class high frequency signals, various modules utilizing a CAN package in which the temperature of a semiconductor optical modulation element is controlled by a temperature control module have been proposed (for example, Japanese Patent No. 5188625 (Patent Literature 1, hereafter) and Unexamined Japanese Patent Application Kokai Publication No. 2011-108937 (Patent Literature 2, hereafter)).

The semiconductor optical modulation device described in the Patent Literature 1 comprises a metal stem, a lead pin running through the metal stem, and a first support block and a temperature control module that are mounted on the metal stem. A first dielectric substrate is mounted on a side of the first support block described in this Patent Literature and a signal line is formed on the first dielectric substrate. Furthermore, a second support block is mounted on the temperature control module described in this Patent Literature and a second dielectric substrate is mounted on a side of the second support block. A signal conductor is formed on the second dielectric substrate and a semiconductor optical modulation element is mounted thereon as well. The semiconductor optical modulation element is connected to the lead pin via first to third bonding wires, the signal line, and the signal conductor.

The TO-CAN (transistor-outlined CAN) TOSA (transmitter optical sub-assembly) module described in the Patent Literature 2 comprises a metal stem on which a signal lead line (lead pin) is fixed with an airtight-sealing dielectric material, a metal nose (first support block) mounted on the stem, and a Peltier element (temperature control module). A relay line substrate (first dielectric substrate) is fixed on the front face of the nose described in this Patent Literature, and a relay line (signal line) is formed on the front face of the relay line substrate. Furthermore, a carrier block (second support block) is mounted on the Peltier element described in this Patent Literature, and a subcarrier substrate (second dielectric substrate) is provided on the front face of the carrier. A relay line (signal conductor) is formed on the subcarrier substrate and an optical semiconductor light source element (semiconductor optical modulation element) is mounted thereon as well. The optical semiconductor light source element is connected to the signal lead line via the relay line on the relay line substrate, the relay line on the subcarrier substrate, and a bonding wire.

As described above, the prior art optical modules disclosed as a semiconductor optical modulation device in the Patent Literature 1 and as a TO-CAN TOSA module in the Patent Literature 2 include the components substantially corresponding as described above. The notation in the Patent Literature I will be used hereafter as collective terms for the corresponding components in the prior art optical modules described in the Patent Literature 1 and 2.

Many semiconductor optical modulation elements produce heat while operating and their temperature rises. Consequently, their characteristics such as the oscillation wavelength significantly change. In order to suppress change in characteristics associated with the temperature rise, the semiconductor optical modulation elements are cooled by a temperature control module. In order to efficiently release heat from the temperature control module, the metal stem is often made of a metal, which is generally a highly heat-conductive material.

As the dielectric material for fixing the lead pin to the stem, glass having a thermal expansion coefficient as high as the metal of the metal stem is often used in order to maintain the airtightness regardless of temperature change. Generally, glass having a high thermal expansion coefficient has a high relative dielectric constant as well.

When the lead pin is enclosed with a high relative dielectric constant glass around the section running through the stem as mentioned above, consequently, impedance mismatch between the lead pin and the semiconductor optical modulation element tends to occur. When multiple reflection, much reflection loss and the like occur due to the impedance mismatch, it is substantially difficult or impossible to transfer 10-Gbps class high frequency signals.

Then, the prior art optical modules are provided with a signal line for impedance matching between the lead pin and semiconductor optical modulation element.

However, as a result of providing a signal line for impedance matching, a problem with the prior art optical modules is high manufacturing cost for the following reasons.

Generally, the temperature control module has a certain height (thickness). Furthermore, in a conventional optical module, a PD (photo diode) element used for monitoring the power of the semiconductor optical modulation element is mounted; therefore, an area for mounting the PD element is required. Because of the height of the temperature control module and the mounting area of the PD element, the distance between the through section of the lead pin and the semiconductor optical modulation element becomes long to some extent. Therefore, the first support block on which the signal line is provided becomes large in dimension as well.

It is practically difficult to integrally mold a large first support block and a metal stem. The first support block is often formed as a separate part from the metal stem and attached to the metal stem by brazing or the like. The labor of attaching the first support block to the metal stem contributes to a high cost of the prior art optical modules.

In the prior art optical modules, the forming a signal line on the first dielectric substrate and attaching the first dielectric substrate to the first support block incur costs. These costs contribute to the high cost of the prior art optical modules.

In the prior art optical modules, a comparatively high relative dielectric constant substrate such as a ceramic substrate is often used as the first dielectric substrate on which a signal line realizing a 10-Gbps class transfer rate is formed. Such a first dielectric substrate is expensive by itself and contributes to the high cost of the prior art optical modules as well.

The present disclosure is made with the view of the above circumstances and an objective of the present disclosure is to provide an optical module that can be manufactured at lower cost.

### SUMMARY

In order to achieve the above objective, the optical module according to the present disclosure comprises:

a metal stem provided with a through-hole;

a lead pin including a through section inserted in the through-hole, and an inner lead section continued from one end of the through section and extending up to the tip;

a semiconductor optical modulation element electrically connected to the inner lead section;

a temperature control module mounted on the metal stem and thermally connected to the semiconductor optical modulation element; and

a metal protrusion formed integrally with the metal stem and facing the inner lead section.

The optical module according to the present disclosure comprises a metal protrusion facing the inner lead section. The protrusion is formed integrally with the metal stem and therefore can easily be provided without labor such as attachment work. Furthermore, the protrusion is made potentially equal to the metal stem and a capacitance component occurs between the protrusion and the inner lead section with an air serving as a dielectric body.

Therefore, the protrusion serves for impedance matching without providing the prior art signal line, first dielectric substrate, and first support block. Therefore, an optical module capable of transferring high frequency signals can be manufactured at lower cost.

### BRIEF DESCRIPTION OF THE DRAWINGS

A more complete understanding of this application can be obtained when the following detailed description is considered in conjunction with the following drawings, in which:

FIG. 1 is a perspective view of the optical module according to Embodiment 1 of the present disclosure;

FIG. 2 is an enlarged view of the inner lead section and protrusion shown in FIG. 1 when seen from the positive Z-axis direction;

FIG. 3 is a graphical representation showing the relationship between the frequency of signals propagated through the lead pin and the reflection characteristic of the inner lead section when the ratio between the distance DIS and diameter DIA is changed;

FIG. 4 is a graphical representation showing the relationship between the frequency of signals propagated through the lead pin and the pass characteristic of the inner lead section when the ratio between the distance DIS and diameter DIA is changed;

FIG. 5 is a graphical representation showing the relationship between the frequency of signals propagated through the lead pin and the reflection characteristic of the inner lead section in the optical module according to Embodiment 1 and the prior art optical module;

FIG. 6 is a graphical representation showing the relationship between the frequency of signals propagated through the lead pin and the pass characteristic of the inner lead section in the optical module according to Embodiment 1 and the prior art optical module;

FIG. 7 is a perspective view of the optical module according to Embodiment 2 of the present disclosure; and

FIG. 8 is a perspective view of the optical module according to Embodiment 3 of the present disclosure.

### DETAILED DESCRIPTION

Embodiments of the present disclosure will be described hereafter with reference to the drawings. The same components will be referred to by the same reference numbers throughout the figures.

### Embodiment 1

The optical module according to Embodiment 1 of the present disclosure is a module converting high frequency electric signals to optical signals and applied, for example, to a CAN package.

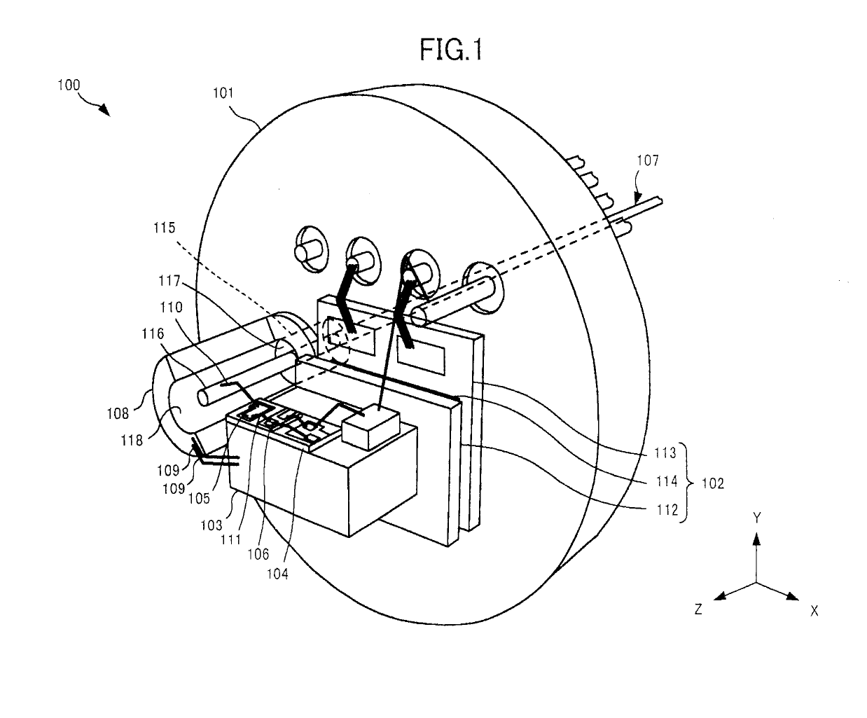

An optical module 100 according to this embodiment comprises, as shown in the perspective view of FIG. 1, a substantially cylindrical metal stem 101, a temperature control module 102 mounted on the metal stem 101, a substantially rectangular parallelepiped support block 103 mounted on the temperature control module 102, a dielectric substrate 104 mounted on a side of the support block 103, a signal line 105 formed on the dielectric substrate 104, a semiconductor optical modulation element 106 mounted on the dielectric substrate 104, a lead pin 107 inserted in the metal stem 101, and a protrusion 108 formed integrally with the metal stem 101 and protruding in the positive Z-axis direction.

The optical module 100 further comprises first bonding wires 109 electrically connecting the support block 103 and protrusion 108, a second bonding wire 110 connecting the lead pin 107 and one end of the signal line 105, and a third bonding wire 111 connecting the other end of the signal line 105 and the semiconductor optical modulation element 106.

Here, as shown in FIG. 1, the positive Z-axis direction is the direction of the lead pin 107 running through the metal stem 101 and extending up to the tip. Furthermore, when seen from the positive Z-axis direction, the rightward direction is the positive X-axis direction and the upward direction is the positive Y-axis direction. These directions are defined for the purpose of explanation and not intended to confine the disclosure according to the present application.

The metal stem 101 is a metal member made of copper, iron, aluminum, stainless-steel, or the like, and has a through-hole running through in the thickness direction thereof (the Z-axis direction). Incidentally, the metal stem 101 can be made of a material coated with gold. nickel, or the like.

The temperature control module 102 is a module for controlling the temperature of the semiconductor optical modulation element 106. The temperature control module 102 comprises, for example, a heat absorber 112 receiving heat, a heat releaser 113 releasing heat, and a Peltier element 114 interposed between the heat absorber 112 and heat releaser 113.

The heat absorber 112 and heat releaser 113 are each, for example, a flat metal member. The heat absorber 112 and heat releaser 113 clamp the Peltier element 114 with one of their respective main surfaces. The heat absorber 112 absorbs heat from the other main surface (heat-absorbing surface) and the heat releaser 113 releases heat from the other main surface (heat-releasing surface). The heat-releasing surface of the heat releaser 113 is attached to the metal stem 101 on the surface facing in the positive Z-axis direction at a position that does not overlap with the through-hole when seen from the positive Z-axis direction.

The support block 103 is made of a thermally and electrically highly conductive material including metals such as copper, iron, aluminum, and stainless-steel and metal-coated insulators such as ceramics and resins. The support block 103 is attached to the heat-absorbing surface of the heat absorber 112 with its one surface facing in the positive Y-axis direction.

The dielectric substrate 104 is a substrate made of a highly heat-conductive dielectric material including ceramics such as alumina and resins such as epoxy. The dielectric substrate 104 is attached to the support block 103 on the surface facing in the positive Y-axis direction and has a main surface facing in the positive Y-axis direction.

The signal line 105 is a wire for transferring signals and is formed on the main surface of the dielectric substrate 104 that faces in the positive Y-axis direction.

Acquiring electric signals, the semiconductor optical modulation element 106 operates according to the electric signals. The semiconductor optical modulation element 106 modulates light from a light source (not shown) such as a semiconductor laser. The semiconductor optical modulation element 106 is mounted on one main surface of the dielectric substrate 104 at a position different from the signal line 105.

Here, the semiconductor optical modulation element 106 can be, for example, a modulator-integrated laser (EAM-LD) in which an electroabsorption optical modulator using an InGaAsP quantum well absorbing layer and a distributed-feedback laser diode are monolithically-integrated or an LiNbO₃ Mach-Zehnder optical modulator. Such a semiconductor optical modulation element 106 produces heat while operating. The heat produced by the semiconductor optical modulation element 106 is transferred to the heat absorber 112 of the temperature control module 102 via the heat-conductive dielectric substrate 104 and support block 103 that are highly heat-conductive. In other words, the semiconductor optical modulation element 106 and the heat absorber 112 of the temperature control module 102 are thermally connected.

The temperature control module 102 transfers the heat received by the heat absorber 112 to the heat releaser 113 via the Peltier element 114 and releases the heat to the metal stem 101 from the heat releaser 113. The heat received by the metal stem 101 from the heat releaser 113 is transferred within the metal stem 101 and released from the surface of the metal stem 101 that faces in the negative Z-axis direction. In this way, the semiconductor optical modulation element 106 is controlled in temperature by the temperature control module 102. Thus, stable operation according, for example, to 10-Gbps class high frequency signals can be continued.

The lead pin 107 is a linear member provided along the Z-axis and serves as a line on which electric signals are propagated. The lead pin 107 can be made of a metal such as copper, iron, aluminum, and stainless-steel, or a material of which the surface is coated with gold, nickel, or the like.

The lead pin 107 includes a through section 115 and an inner lead section 116 as shown in FIG. 1. The through section 115 is the section inserted in the through-hole of the metal stem 101 (the section positioned in the through-hole) and is fixed to the metal stem 101 with a glass material 117 sealing the through-hole of the metal stem 101 in an airtight manner. the inner lead section 116 is continued from the end of the through section 115 in the positive Z-axis direction and extends up to the tip.

The protrusion 108 is a metal block formed integrally with the metal stem 101. The protrusion 108 protrudes in the positive Z-axis direction from the surface of the metal stem 101 that faces in the positive Z-axis direction and thus faces the inner lead section 116. More specifically, the protrusion 108 has a curved surface 118 facing at least part of the inner lead section 116.

Here, generally, adjustment is made to reduce the inductance component of the inner lead section 116 and make the characteristic impedance of the lead pin 107 closer, for example, to a general standard value of 50 Ω. Thus, it is possible to reduce reflection of electric signals propagated through the lead pin 107 and assure a wide pass band. Consequently, an optical module capable of transferring, for example, 10-Gbps class high Frequency signals can be realized.

The length of the inner lead section 116 is relevant to the inductance component intrinsic to the inner lead section 116. The longer the inner lead section 116 is, the greater the parasitic inductance tends to become. Therefore, from the viewpoint of reducing the inductance component of the inner lead section 116, it is desirable that the length of the inner lead section 116 is smaller.

The characteristic impedance of the inner lead section 116 is determined by the capacitance component created by the protrusion 108, inner lead section 116 in addition to the inductance component and so on. Furthermore, the capacitance component is determined in accordance with the area S in which the curved surface 118 of the protrusion 108 and the outer peripheral surface of the inner lead section 116 face and the distance DIS between these surfaces. From the viewpoint of making the characteristic impedance closer to a standard value, generally, it is desirable that the facing area S is larger and the distance DIS is smaller.

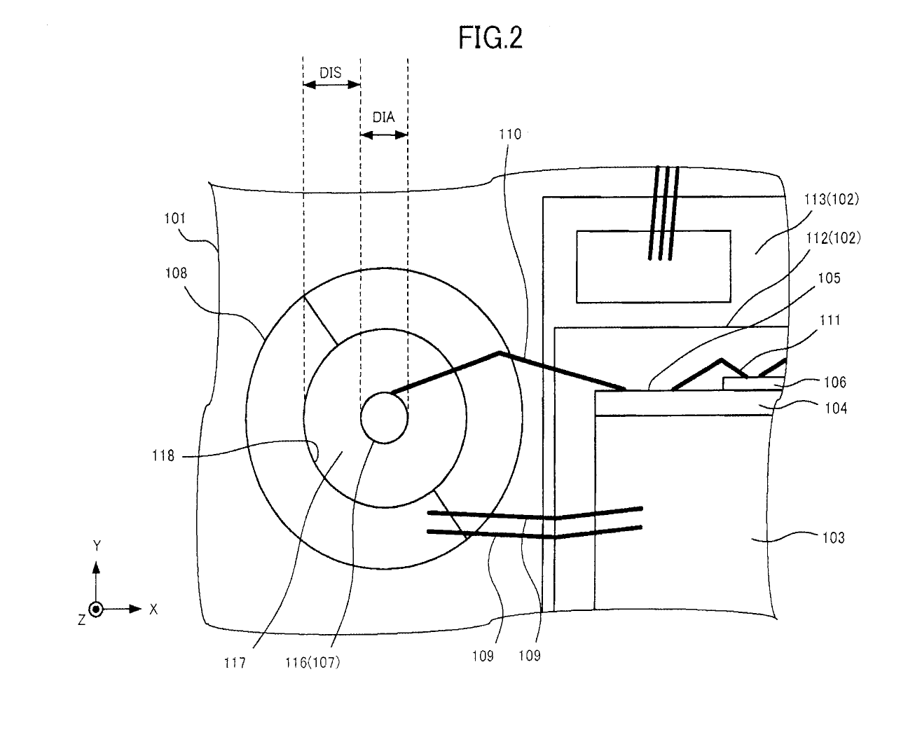

In order to increase the facing area S, the curved surface 118 of the protrusion 108 according to this embodiment is provided in parallel to and spaced by an equal distance DIS From the outer peripheral surface of the inner lead section 116, as shown in FIG. 2 that is an enlarged view when seen from the positive Z-axis direction. As shown in FIG. 2, the inner lead section 116 is conventionally circular when seen from the positive Z-axis direction; therefore, the curved surface 118 spaced by an equal distance DIS is circular or arc-shaped.

The shape of the protrusion 108 is determined so as to assure a region for providing the second bonding wire 110. Furthermore, in order to reduce the inductance component of the second bonding wire 110, it is desirable that the inner lead section 116 is closer to the temperature control module 102 and support block 103. As a preferable shape of the protrusion 108 from such a viewpoint, the protrusion 108 according to this embodiment has a semicircular shape from the negative X-axis direction to the negative Y-axis direction inclusive (a shape formed by two concentric semicircles connected by lines at their ends) as shown in FIG. 2. Then, the curved surface 118 according to this embodiment is in the shape of a semicircle from the negative X-axis direction to the negative Y-axis direction inclusive when seen from the positive Z-axis direction as shown in the figure.

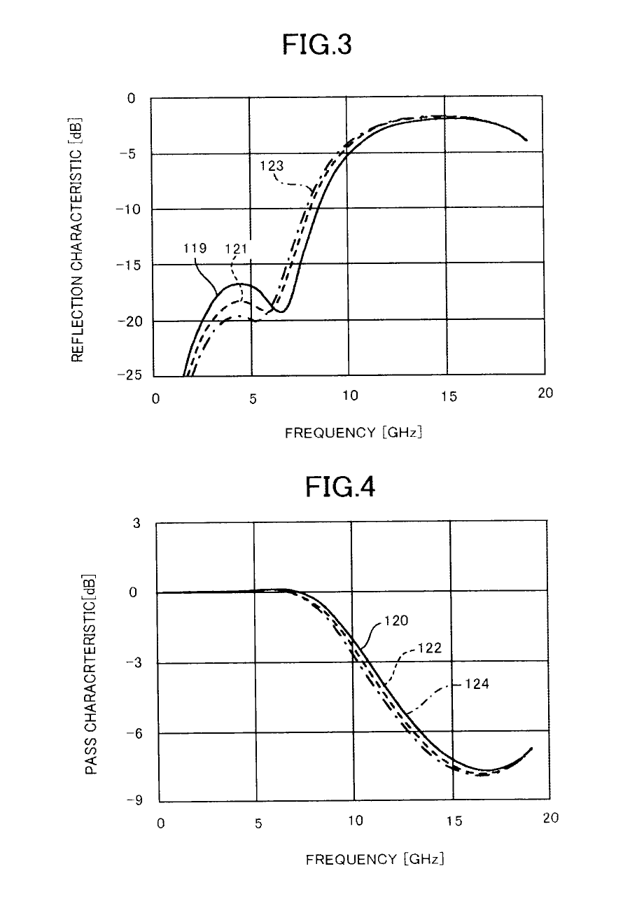

Here, FIG. 3 shows the relationship between the frequency of signals propagated through the lead pin 107 and the reflection characteristic of the inner lead section 116 that is seen from the through section 115 when the ratio between the distance DIS and the diameter DIA of the inner lead section 116 (see FIG. 2) is changed. FIG. 4 shows the relationship between the frequency of signals propagated through the lead pin 107 and the pass characteristic of the inner lead section 116 that is seen from the through section 115 when the ratio between the distance DIS and the diameter DIA is changed.

In FIGS. 3 and 4, the reflection characteristic or pass characteristic of the optical module according to this embodiment (the distance DIS is 1.2 times greater than the diameter DIA) is shown by a solid line 119 or 120. The reflection characteristic or pass characteristic of an optical module in which the distance DIS is 1.7 times greater than the diameter DIA is shown by a broken line 121 or 122. The reflection characteristic or pass characteristic of an optical module in which the distance DIS is 2.5 times greater than the diameter DIA is shown by a dash-dot line 123 or 124. In any case, only the dimension of the distance DIS with reference to the diameter DIA of the inner lead section 116 is different and the other conditions such as the shape of the protrusion 108 are the same.

It is assumed that, for example, the reflection characteristic of −5 dB or lower should be assured at frequencies of 10-GHz and lower in order to deal with 10-Gbps class high frequency signals. In such a case, it is understood from FIG. 3 that the distance DIS that is 2.5 times or 1.7 times greater than the diameter DIA is unsatisfactory and the distance DIS that is 1.2 times greater than the diameter DIA is satisfactory.

As for the frequency band of which the pass characteristic is −3 dB or lower in FIG. 4, the margin to 10 GHz is increased in the order of the distance DIS being 2.5 times, 1.7 times, and 1.2 times greater than the diameter DIA.

Therefore, the optical module 100 according to this embodiment in which the distance DIS is 1.2 times greater than the diameter DIA can satisfactorily deal with 10-Gbps class high frequency signals. Incidentally, as understood from FIGS. 3 and 4, it is desirable for dealing with 10-Gbps class high frequency signals that the distance DIS is up to 1.5 times greater than the diameter DIA.

FIG. 1 is referred to again hereafter. The first bonding wires 109 are wires to make the support block 103 and metal stem 101 potentially equal. Thus, the support block 103 has the reference potential, making it possible to substantially prevent deterioration of high frequency signals. Particularly, this matter plays an important role particularly for enabling transfer of 10-GHz class high frequency signals.

Incidentally, the support block 103 can be connected to the metal stem 101 directly. not via the protrusion 108, by the first bonding wires. Also in this way, the support block 103 and metal stem 101 are made potentially equal, making it possible to substantially prevent deterioration of high frequency signals. Incidentally, the first bonding wire 109 may comprise of one or more wire. Also in this way, the support block 103 and metal stem 101 are made potentially equal, making it possible to substantially prevent deterioration of high frequency signals.

The second bonding wire 110 and third bonding wire 111 electrically connect the semiconductor optical modulation element 106 and lead pin 107 together with the signal line 105. Thus, the semiconductor optical modulation element 106 can acquire electric signals propagated through the lead pin 107 and modulate light from the light source (not shown) according to the electric signals. Consequently, the electric signals propagated through the lead pin 107 can be converted to optical signals.

### Embodiment 1 of the Present Disclosure is Described Above

According to this embodiment, the protrusion 108 facing the inner lead section 116 is provided. Since the protrusion 108 and metal stem 101 are integrally molded as a metal member, the protrusion 108 and metal stem 101 are potentially equal. Therefore, with the air serving as a dielectric body, a capacitance component occurs between the inner lead section 116 and protrusion 108. Thus, it is possible to reduce multiple reflection and reflection loss due to impedance mismatch of the lead pin 107 and realize an optical module capable of transferring high frequency signals.

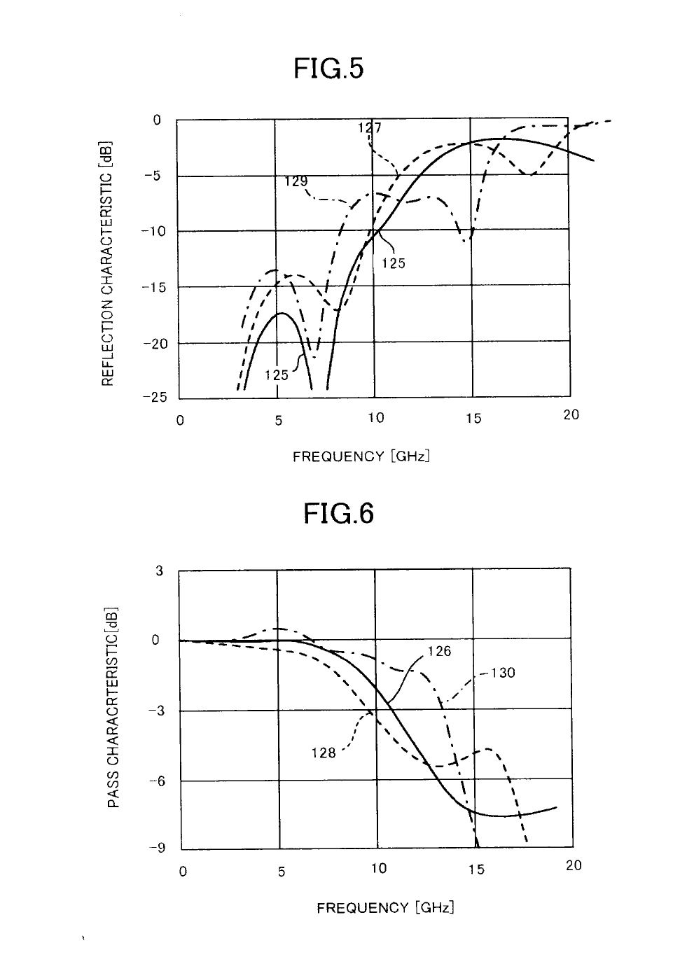

It will be described hereafter with reference to FIGS. 5 and 6 that the optical module 100 according to this embodiment is capable of transferring 10-Gbps class high frequency signals. FIG. 5 shows the relationship between the frequency of signals propagated through the lead pin 107 and the reflection characteristic of the inner lead section 116 that is seen from the through section 115 in the optical module 100 according to this embodiment and a prior art optical module (the semiconductor optical modulation device disclosed in Japanese Patent No. 5188625 in this embodiment). FIG. 6 shows the relationship between the frequency of signals propagated through the lead pin 107 and the pass characteristic of the inner lead section 116 that is seen from the through section 115 in the optical module 100 according to this embodiment and the prior art optical module.

In FIGS. 5 and 6, the reflection characteristic or pass characteristic of the optical module according to this embodiment is shown by a solid line 125 or 126. The reflection characteristic or pass characteristic of the prior art optical module without the dielectric substrate (the semiconductor optical modulation device disclosed in Japanese Patent No. 5188625 from which the first dielectric substrate has been removed) is shown by a broken line 127 or 128. The reflection characteristic or pass characteristic of the prior art optical module with the dielectric substrate is shown by a dash-dot line 129 or 130.

It is assumed that, for example, the reflection characteristic of −5 dB or lower should be assured at frequencies of 10 GHz and lower and the pass band of −3 dB or lower should be assured at 10 GHz and higher in order to deal with 10-Gbps class high frequency signals. In such a case, with reference to FIGS. 5 and 6, it is understood that the prior art optical module without the dielectric substrate is unsatisfactory for dealing with 10-Gbps class high frequency signals. Furthermore, it is understood that the optical module 100 according to this embodiment and the prior art optical module with the dielectric substrate can satisfactorily deal with 10-Gbps class high frequency signals.

In other words, according to this embodiment, the first support block and first dielectric substrate used by the prior art optical module for dealing with 10-Gbps class high frequency signals are unnecessary. Furthermore, the protrusion 108 of the optical module 100 according to this embodiment is formed integrally with the metal stem 101. Thus, a factor of the high cost in the prior art can be eliminated.

Therefore, according to this embodiment, it is possible to manufacture an optical module capable of transferring high frequency signals at lower cost.

In this embodiment, the surface of the protrusion 108 that faces the inner lead section 116 is the curved surface 118 parallel to the outer peripheral surface of the inner lead section 116 so as to increase the facing area S. Furthermore, the distance DIS between the curved surface 118 and the outer peripheral surface of the inner lead section 116 is uniform so as to increase the facing area S. These matters serve to shorten the inner lead section 116 and reduce the parasitic inductance component while increasing the parasitic capacitance component of the inner lead section 116.

In this embodiment, since the curved surface 118 of the protrusion 108 is semicircular when seen from the positive Z-axis direction, the curved surface 118 parallel to the inner lead section 116 and spaced by an equal distance DIS can be realized. Thus, the facing area S can be increased as much as possible. Consequently, it is possible to minimize multiple reflection and reflection loss due to impedance mismatch of the inner lead section 116 and realize an optical module 100 capable of transferring 10-Gbps class high frequency signals.

The first bonding wires 109 according to this embodiment electrically connect the support block 103 and protrusion 108 to make the support block 103 and metal stem 101 potentially equal. Thus, it is possible to substantially prevent deterioration of high frequency signals.

Furthermore, as mentioned above, the first bonding wires can connect the support block 103 and metal stem 101 directly. In such a case, the heat released to the metal stem 101 from the temperature control module 102 may be transferred to the support block 103 via the first bonding wires. Consequently, the efficiency of the support block 103 transferring the heat produced by the semiconductor optical modulation element 106 to the temperature control module 102 may drop and the efficiency of cooling the semiconductor optical modulation element 106 may drop.

In contrast, since the first bonding wires 109 according to this embodiment are connected to the protrusion 108, a very small amount of heat of the metal stem 101 is transferred to the support block 103 via the first bonding wires 109 if any. Particularly, as shown in FIGS. 1 and 2, when the first bonding wires 109 are connected to the tip of the protrusion 108, almost no heat is transferred to the support block 103 from the metal stem 101 via the first bonding wires 109.

Therefore, according to this embodiment, it is possible to improve the efficiency of cooling the semiconductor optical modulation element 106 and substantially prevent deterioration of high frequency signals.

### Embodiment 2

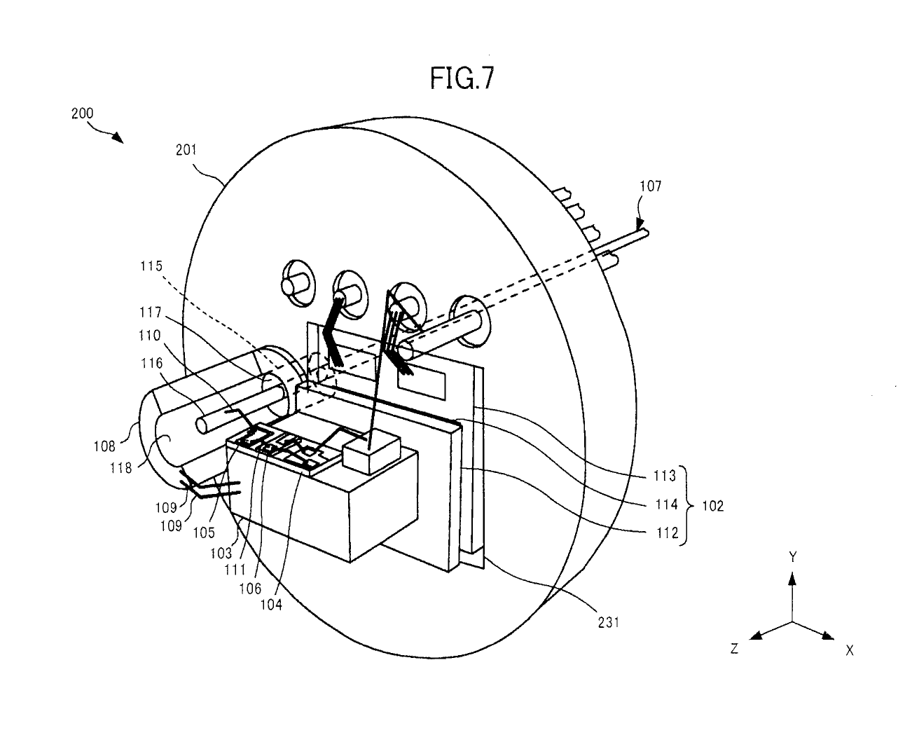

An optical module 200 according to Embodiment 2 of the present disclosure comprises, as shown in the perspective view of FIG. 7, substantially the same configuration as the optical module 100 according to Embodiment 1. The major difference between the optical module 200 and the optical module 100 according to Embodiment 1 is that a metal stem 201 of the optical module 200 according to this embodiment has a recess 231.

The recess 231 is provided in the metal stem 201 as a region for mounting the temperature control module 102. As shown in FIG. 7, the recess 231 is recessed in the negative Z-axis direction and has a substantially rectangular flat surface facing in the positive Z-axis direction.

In this embodiment, the temperature control module 102 is mounted on the flat surface of the recess 231 that faces in the positive Z-axis direction. Thus, the semiconductor optical modulation element 106 is positioned closer to the metal stem 201 in the Z-axis direction compared with in the optical module 100 according to Embodiment 1. Therefore, in this embodiment, the inner lead section 116 can further be shortened compared with that according to Embodiment 1.

As the length of the inner lead section 116 is reduced, as described above, the parasitic inductance can be reduced. Consequently, in this embodiment, it is possible to further reduce multiple reflection and reflection loss of the inner lead section 116 and assure a wider pass hand in addition to the same effect as Embodiment 1.

### Embodiment 3

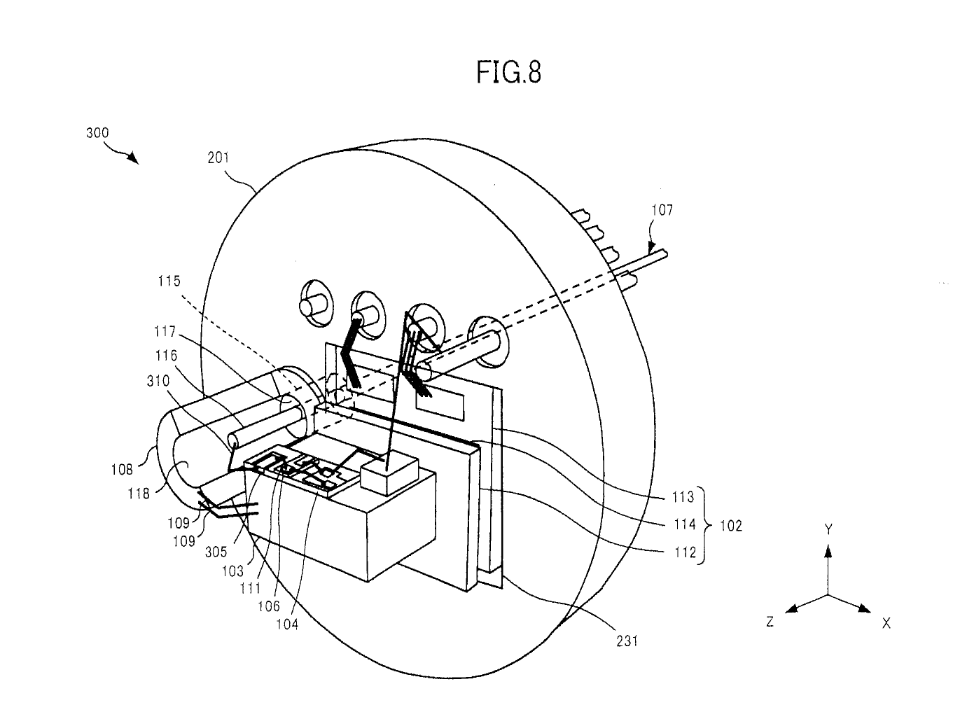

An optical module 300 according to Embodiment 3 of the present disclosure comprises, as shown in the perspective view of FIG. 8, substantially the same configuration as the optical module 200 according to Embodiment 2. The major difference between the optical module 300 and the optical module 200 according to Embodiment 2 is that the optical module 300 according to this embodiment comprises a signal line 305 and a second bonding wire 310 in place of the signal line 105 and second bonding wire 110 according to Embodiment 1.

The signal line 305 is formed on the dielectric substrate 104 from a main surface (the surface facing in the positive Y-axis direction) to a side (the side facing in the positive Z-axis direction).

The second bonding wire 310 connects the tip of the inner lead section 116 and one end of the signal line 305 formed on the one side of the dielectric substrate 104.

According to this embodiment, since the signal line 305 is formed on the one side of the dielectric substrate 104, the signal line 305 can easily be connected to the tip of the inner lead section 116 without intricate wiring of the second bonding wire 310. Then, with the second bonding wire 310 being connected to the tip of the inner lead section 116, in this embodiment, the inner lead section 116 can be shorten compared with that according to Embodiment 2.

As the length of the inner lead section 116 is reduced, as described above, the parasitic inductance can be reduced. Consequently, in this embodiment, it is possible to further reduce multiple reflection and reflection loss of the inner lead section 116 and assure a wider pass band in addition to the same effect as Embodiment 2.

Embodiments of the present disclosure are described above. The present disclosure is not confined to the embodiments and includes modes in which the embodiments and modified embodiments are properly combined and their modified modes.
100, 200, 300 Optical module
101, 201 Metal stem
102 Temperature control module
103 Support block
104 Dielectric substrate
105, 305 Signal line
106 Semiconductor optical modulation element
107 Lead pin
108 Protrusion
109 First bonding wire
110, 310 Second bonding wire
111 Third bonding wire
115 through section
116 Inner lead section
118 Curved surface
231 Recess

What is claimed is:

1. An optical module, comprising:
a metal stem provided with a through-hole;
a lead pin including a through section inserted in the through-hole, and an inner lead section continued from one end of the through section and extending up to the tip;
a semiconductor optical modulation element electrically connected to the inner lead section:
a temperature control module mounted on the metal stem and thermally connected to the semiconductor optical modulation element; and
a metal protrusion formed integrally with the metal stem and facing the inner lead section.

2. The optical module according to claim 1, wherein
the protrusion comprises a curved surface parallel to part of the outer peripheral surface of the inner lead section.

3. The optical module according to claim 2, wherein
the curved surface is spaced from the outer peripheral surface by an equal distance.

4. The optical module according to claim 3, wherein
the distance is up to 1.5 times greater the diameter of the inner lead section.

5. The optical module according to claim 1, further comprising;
a support block mounted on the temperature control module;
a dielectric substrate that is mounted on a side of the support block and on which the semiconductor optical modulation element is mounted; and
a first bonding wire making the support block and metal stem potentially equal.

6. The optical module according to claim 5, wherein
the first bonding wire connecting the support block and the protrusion.

7. The optical module according to claim 5, further comprising;
a signal line formed on the dielectric substrate;
a second bonding wire connecting the lead pin and one end of the signal line; and
a third bonding wire connecting the other end of the signal line and the semiconductor optical modulation element.

8. The optical module according to claim 7, wherein
the signal line is formed on the dielectric substrate from a main surface to a side thereof, and
the second bonding wire connecting the tip of the inner lead section and the one end of the signal line that is formed on the side of the dielectric substrate.

9. The optical module according to claim 1, wherein
the metal stem comprises a recess recessed in the direction from the tip of the inner lead section to the through section, and
the temperature control module is mounted in the recess.
